(19) United States
(12) Patent Application Publication
(10) Pub. No.: US 2013/0143182 A1
(43) Pub. Date: Jun. 6, 2013

(54) METHOD AND SYSTEM OF TOOLS FOR HELPING PERSONS TO BECOME LEAN AND HEALTHY

(71) Applicant: Crossan IP Law, LLC, Chicago, IL (US)

(72) Inventor: Guy Bruce, Chicago, IL (US)

(73) Assignee: Crossan IP Law, LLC, Chicago, IL (US)

(21) Appl. No.: 13/690,024

(22) Filed: Nov. 30, 2012

Related U.S. Application Data
(60) Provisional application No. 61/566,141, filed on Dec. 2, 2011.

(51) Int. Cl. G09B 19/00

(52) U.S. Cl. CPC G09B 19/0092
USPC 434/127

(57) ABSTRACT

A system and method by which users desiring to improve and maintain their health, to resist disease and bodily malfunction, increase their productivity, and decrease their health care costs may record their daily activities, food intake, and various health measures on an internet-based web site. Software at the site provides an automated shaping process, setting individualized eating, activity, and health progress goals, using a formula that increases the probability that each goal will be achieved, immediately informing the user when he or she has made progress towards or achieved a goal, and awards points which users can exchange for their choice of incentives. Graphic feedback on user progress towards long-term eating, activity and health goals is provided. It calculates the number of current lifestyle disease risk factors from user eating, activity, and health measures and provides individualized advice on how to reduce disease risk. A health coach may be engaged.

This application timely claims the benefit of the filing date and disclosure of the pending Provisional Patent Application filed Dec. 2, 2011, as Ser. No. 61/566,141.

### 1. FIELD OF THE INVENTION

The present invention is an internet-based method and system that helps users change their eating and activity choices in order to improve their health. It provides an automated shaping process that allows users to record their food and liquid intake, activity and sleep duration, smoking and health measures, sets individualized daily progress goals to increase healthy eating, activity, and sleep duration and to decrease smoking and unhealthy eating and activity choices, immediately informs the user when he or she achieves a goal, and awards incentive points which users can exchange for their choice of incentives. The system also informs users of their current modifiable disease risk factors and progress towards reducing them, based on the user's current and previously recorded behavior and health measures. It also provides resources such as healthy recipes and menus. Information, in a question and answer database from research on the effects of eating and activity choices on disease risk is also provided. The system teaches how to make healthy choices with interactive activities, connects users to other users through a private list serve, and advises users on healthy eating and activity choices, including those that will reduce the individual's current disease risk factors.

### 2. BACKGROUND OF THE ART

The Internet has many pages and sites with healthy living advice, dietary plans, exercise regimens, and simple recording of eating and exercise choices, some providing simple feedback on caloric intake and expenditure, amount of basic nutrients consumed or points earned. None is known to provide an automated, individualized shaping process in which measures of the user's current eating, activity, and health—which medical research has shown to affect disease risk—are used to set daily, weekly, and monthly goals. A formula designed to increase the probability that current goals will be achieved is used. The user is immediately informed when he or she has met a goal, and points are awarded which the user may exchange for an incentive prize. New progress goals are set for the next day or period. The shaping process, technically defined as the differential reinforcement of successive approximations to a target behavior, has been shown to be very effective in teaching a variety of novel behaviors.

### SUMMARY OF THE INVENTION

Disclosed is a web-based software application that provides a comprehensive set of tools to help people change their eating and activity choices in order to reduce their disease risk.

The present method and system allows users to record their eating, drinking, activity, sleep, smoking, and smoking alternatives by typing keywords into a search field or clicking on buttons next to these options, clicking on the name of the specific food or activity, and then typing the amount of that food consumed or the duration of the activity. Each food or activity included in the database includes detailed information about that item. For foods, the database contains the full set of nutrient values that research has shown to be related to increased or decreased disease risk. For activities, the database includes the calorie expenditure per minute and the classification of that activity as cardiovascular, strength building, and relaxation.

Users are able to access the information about each food or activity in the database by clicking on that item. Each food has been categorized as healthy, cautionary, or unhealthy according to research-based criteria on the disease risk correlated with eating that food. The food is marked as green, yellow, or red to identify or include its category. Users can request that additional foods or activities be added to the database, by clicking on a “request foods” or “request activities” link, which allows them to send information about the food or activity to a dietitian or exercise physiologist, provided as part of the method and system. Users can also obtain healthy recipes for many items in the database by clicking on the recipe link. Users may also access menus that have been developed and taste tested by dietitians and in pilot test groups. The system and method also has a feature that allows users to create their own recipes or workout routines, composed of items in the eating or activity databases. In addition, users may add their favorite foods or activities to a personal favorites database. The system and method also provides users with a question and answer database that provides summaries and recommendations about healthy eating and activities from current research.

The present system and method allows users to record a variety of health measures that predict disease risk. The more frequently recorded measures are body fat, lean body mass, waist circumference, diastolic and systolic blood pressure, heart recovery rate, carbon monoxide (for smokers). Less frequently recorded measures include cholesterol (LDL, HDL, and total), C-reactive protein, glucose, homocysteine, triglycerides, and Hemoglobin A1C. Users may also record their health expenses. They may obtain information about how to record these measures, the research-based values that predict reduced disease risk, and the benefits of achieving those values, by clicking on an information link for each measure.

The method and system sets easy to achieve personal progress goals based on the individual's last seven days of eating and activity measures and the user's last two health measures. These goals extend far beyond the usual calorie intake and expenditure measures to include goals for healthy eating and activity choices based on the best research. For example, goals for healthy eating include grams and ratios of different types of fats, ratios of plant to animal protein, fiber and glycemic load, caloric density, vitamins and minerals, water, as well as a number of healthy, cautionary, and unhealthy servings as defined by the research on disease risk. Goals for healthy activity include minutes spent in each of three types of activities, cardiovascular, strength building, and relaxation. Smokers have goals for both reducing number of cigarettes smoked and increasing the number of healthy alternatives. In addition, the program of the system and method includes setting goals for balance between calorie intake and expenditure. The program also sets easy to achieve personal progress goals for the health measures previously listed. The program automatically calculates and updates personal progress goals every day so the goals are always based upon the user's last seven days of entries, using a shaping process formula designed to increase the probability that each goal will be achieved by the user. The system calculates the average of the last seven days, for instance, of user-recorded food and activity choices for each of the measures listed above, e.g., average grams of fiber or average duration of cardiovascular activity. It then calculates the next goal, such as a daily goal, for each measure as the average of the user's highest value and the average value for the measure during the last seven days. Because this formula sets the current goal within the current variability of user choices, higher than the average but lower than the best value, it should increase the probability that the current goal will be achieved. At the beginning of each new 24-hour cycle, the process automatically recalculates the entire set of user eating and activity goals, so that they are always based on the last seven days of user measures.

The present system and method provides immediate feedback each time a user records an eating, activity, or health measure or achieves a daily eating or activity progress goal or longer term healthy progress goal, and it awards points immediately for achieving each goal. Immediate feedback on progress towards achieving daily goals is displayed in a set of dials on the screen where the user has recorded eating, activity, or health measures. Each dial shows the current progress goal as a line separating red and green sections of the dial and as a number just below the dial. The current value of the measure is shown with a needle that points to the current value of that measure along the dial. The feedback for achieving a goal is a text message informing the user that he or she has achieved specific progress goals and showing the number of points that the user has earned for achieving those goals, along with an optional, auditory applause clip. Feedback on achieving goals that are based on daily maximum intake values is provided at the end of the user's recording day, when the user has informed the central program computer that he or she has finished recording for that day. The method and system also provides feedback on progress towards meeting longer-term goals by displaying eating, activity and health measures across week and months of user interaction with long-term goals indicated by horizontal lines on the charts.

### BRIEF DESCRIPTION OF THE DRAWINGS

FIG. 1 shows the home page of an Internet site for interacting with a specific user, showing body shape feedback, incentive points, the Health Plan Wizard, and links to program features.

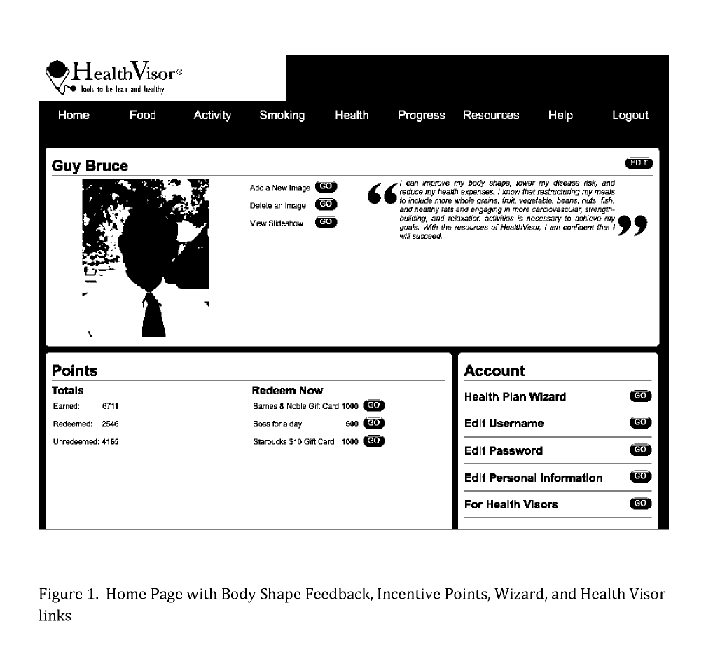

FIG. 2 shows the page where users can get information and advice about foods and liquids, record their food and liquid intake, and get feedback on their progress towards achieving healthy eating goals.

FIG. 3 shows feedback on healthy eating progress goals achieved and incentive points earned by a user.

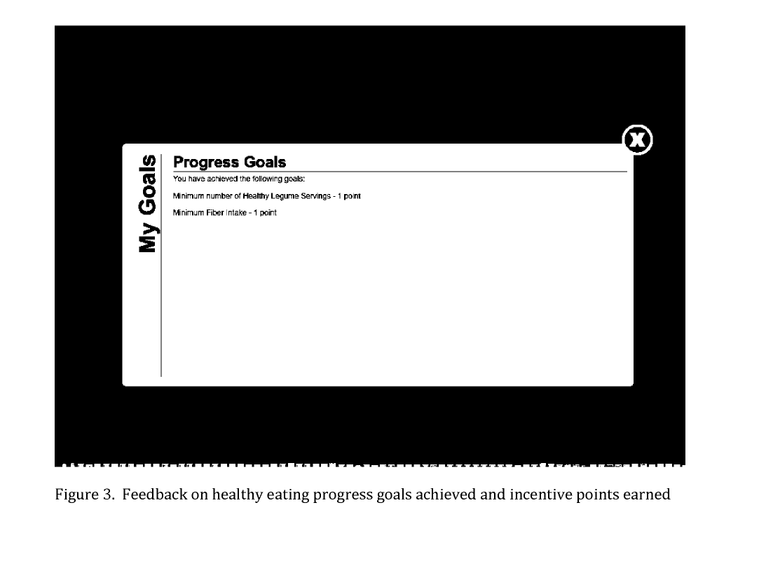

FIG. 4 shows the page where users can get information about activities, record their activities, and get feedback on their progress towards achieving healthy activity goals.

FIG. 5 shows feedback on healthy activity progress goals achieved and incentive points earned.

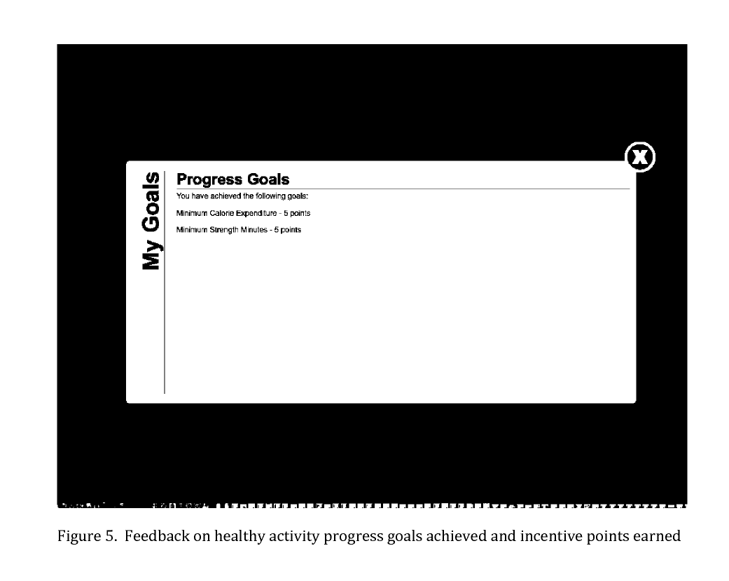

FIG. 6 shows the page where users can get information and advice about frequently recorded health measures, record their current health measures, and get feedback on their progress towards achieving these health progress goals.

FIG. 7 shows the page where users can get information and advice about less frequently recorded health measures, record their current health measures, and get feedback on their progress towards achieving these health progress goals.

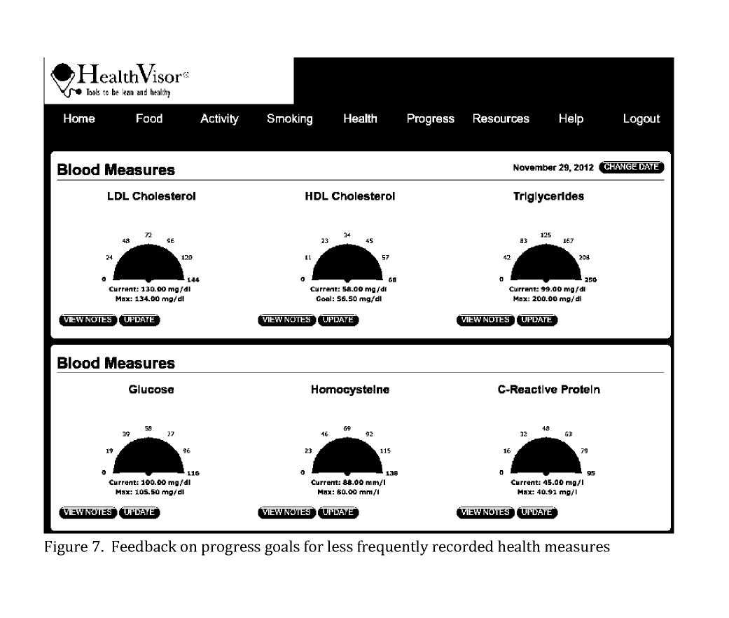

FIG. 8 shows the page where users can record smoking and alternative activities and get feedback on their progress towards achieving their smoking reduction progress goals.

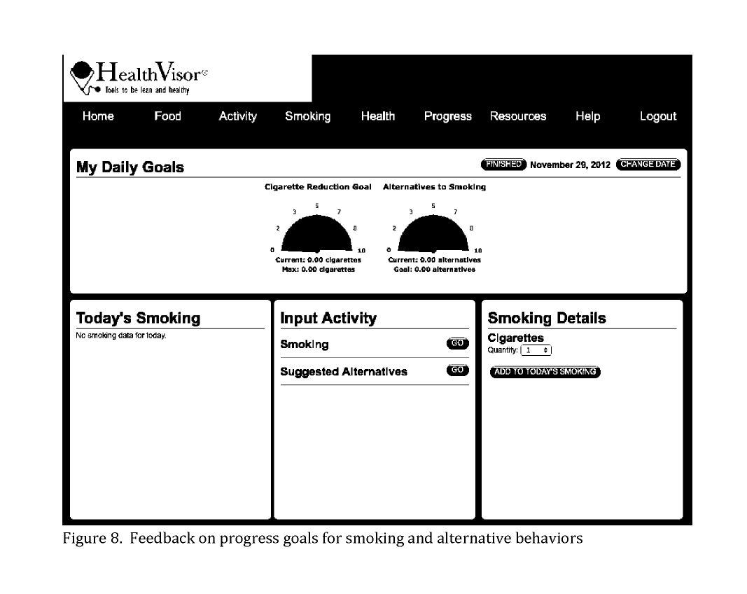

FIG. 9 shows the page where users can get feedback on their progress in reducing disease risks factors and get individualized advice to the user.

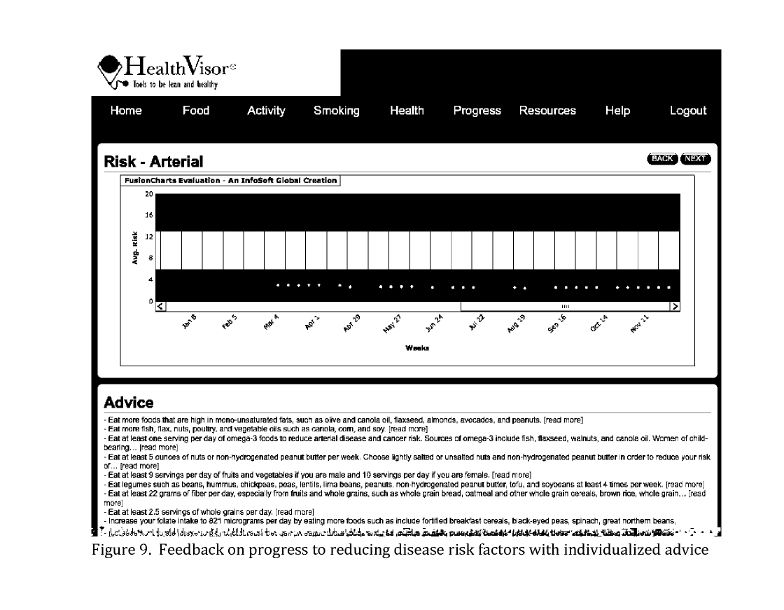

FIG. 10 shows a learning efficiency progress chart for one learner's progress towards mastery of a learning program objective.

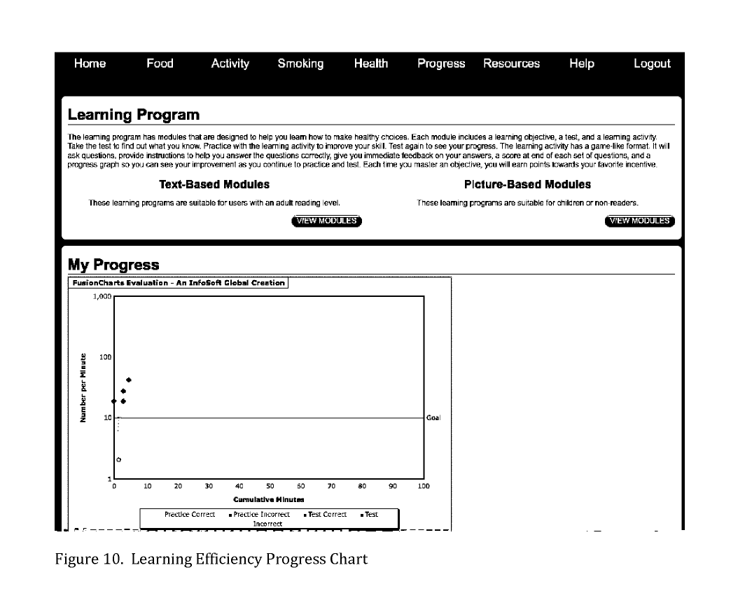

FIG. 11 provides healthy menus for multiple weeks, with nutrition details.

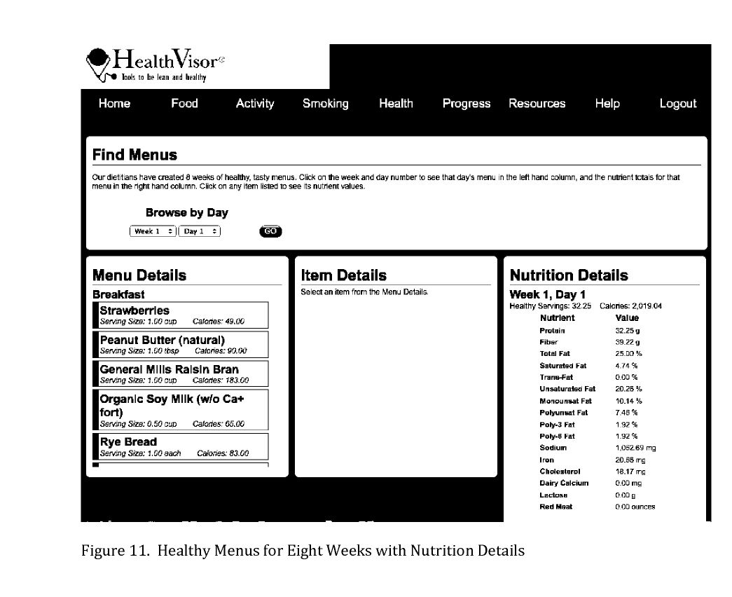

FIG. 12 provides a recipes database, color-coded as healthy, cautionary, or unhealthy, with nutrient values listed for each recipe.

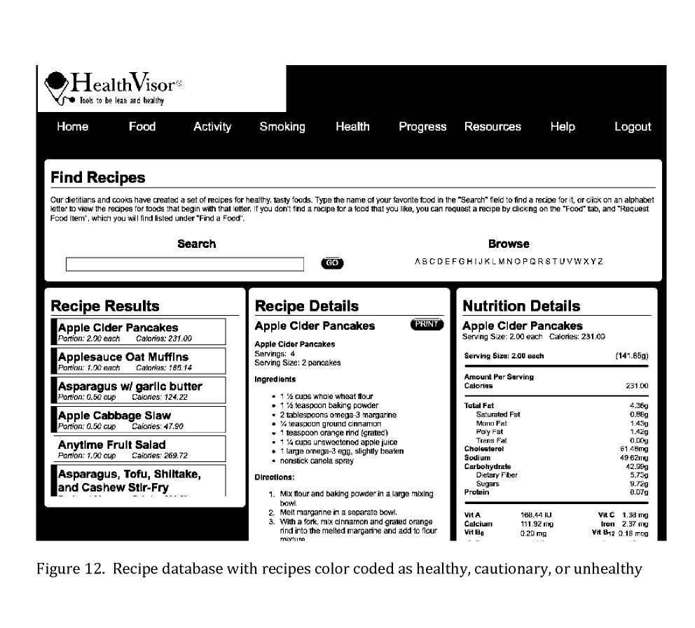

FIG. 13 shows a database that users can search to find answers to their questions about health research.

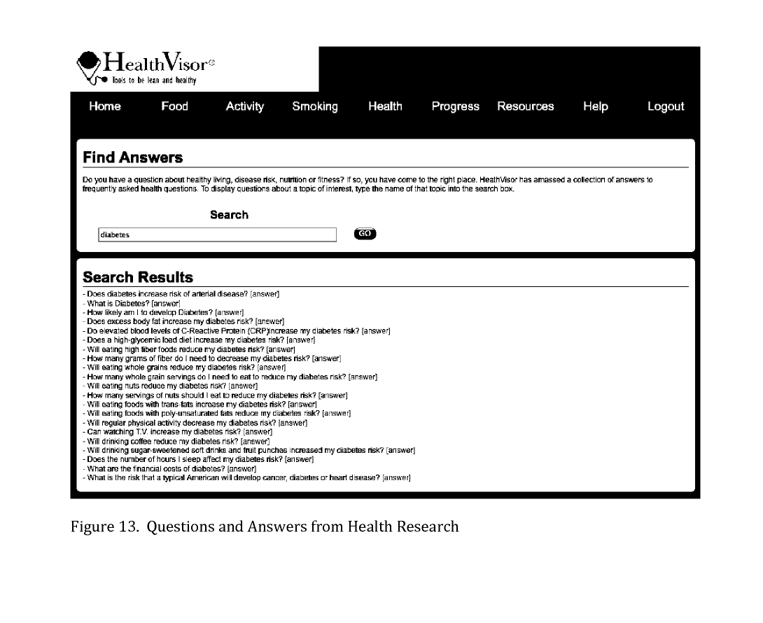

FIG. 14 provides a link to a community forum for members and coaches.

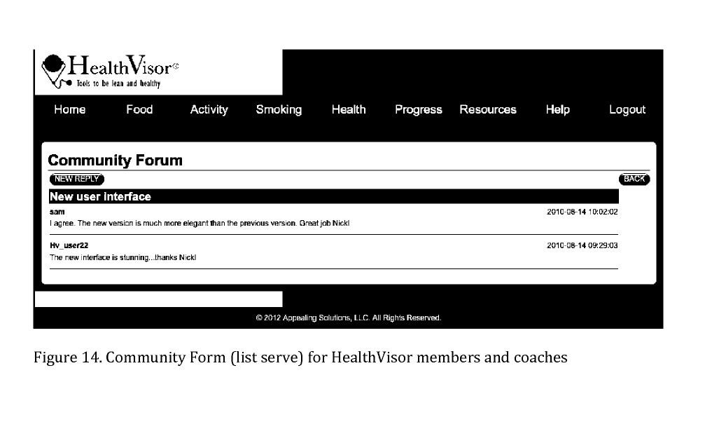

### THE PREFERRED EMBODIMENT

The method and system provides graphic feedback on the current day's eating, activity, and most recent health measures in the form of dials that display measures of nutrient, activity, and health measures based on user entries and values associated in the program's database for each item. For example, if the user records that he ate one apple, the system will add or calculate the amount of fiber, flavonoids, type of fats, glycemic load, plant protein, and other nutrient values and add those values to the previous daily totals for each of those measures. In addition, the system will calculate and display the current progress goal on each dial. Eating, activity, and health measures are calculated and updated by the program each time the user records them.

The drawing figures show an exemplary set of Internet-based screens of a system and method for implementing one form of this invention, from the Home screen through data recording and feedback screens to a community forum screen or link. Color-coding assists the user in identifying progress and goals.

The present method and system allows users to accumulate and exchange points they have earned, by achieving eating, activity, and health progress goals, for incentives that the user can choose. Users are able to view their current point totals and a list of incentive items with the points required for exchange listed next to each item. Administrators are able to set the point values required to obtain each incentive and to add to and update the list of incentives.

The method and system automatically calculates and graphs the number of preventable risk factors for arterial disease, cancer, diabetes, osteoporosis, and respiratory disease, based on the user's last seven days for recorded eating, activity, and most recent health measures, and it automatically updates these graphs every day. Users may view graphs of the number of current risk factors and how these have changed over time for each of the lifestyle-related diseases, arterial (coronary, cerebrovascular, peripheral), cancer, diabetes, osteoporosis, and respiratory diseases. The user's number of risk factors is color-coded in bands of green, yellow, and red. The method and system displays advice on how to reduce each of the user's current risk factors by changing eating and activity choices.

In addition to graphs of risk factors, the method and system displays user progress feedback graphs for all eating, activity, and health measures recorded by the user. These graphs allow users to evaluate visually how these measures are changing over time and to compare current measures to long-term goals set according to the best current research on the effect of life-style choices on disease risk.

The method and system also provides feedback on changes in the user's body shape with a feature that allows the user to import digital photos of him or her-self. The system and method time-stamps each photo and then plays the photos in a slide show so that users can view changes in their body shape over time.

The method and system also includes a learning program that has a game-like format, with features such as a) pre- and post-testing, b) a learning activity with instructions, practice, and immediate feedback, c) a progress graph that shows the user's improvement per amount of time spent practicing, and d) automatic sequencing through the pre-test, learning activities, and post-test, based on the learner's performance. Achieving learning goals also earns incentive points. Another feature of the learning programs is that the instructions that help learners proceed correctly are available during practice, whenever the learner requests them. Another feature is that accuracy and speed of performance, as well as learning efficiency (considered as the improvement in accuracy and speed per amount of time the learner spent interacting with the learning activity), are displayed on learner progress graphs at the end of each learning activity or test session.

The method and system has a wizard feature that helps users set up their personal accounts and a personal coaching feature. If the user requests coaching, the system will provide the coach with on-line access to the user's account. The feature allows only approved coaches to record health measures for assigned users. For users who want social support, the program advantageously provides a list serve that allows them to send and receive e-mails to other users and their advisors and to system administrators. Finally, users will be able to access the method and system via their smart phones having messaging and on-line capabilities.

Thus, the present method and system sets easy to achieve personal progress goals for a variety of eating, activity, and health measures. These goals are automatically calculated and updated every day based on the individual's recorded choices over the previous seven days. The formula for setting the goals is as follows: a) Add the values for a particular measure from the last 7 days of recorded food or activity choices. b) Divide that total by 7. c) If the current average is less than the long-term goal, add the average to the highest recorded value for the measure during the last seven days, then divide by 2. If the current average is greater than the long-term goal, add the current average to the lowest recorded value for the measures during the last seven days, then divide by 2. No other application is believed to have a similar automated progressive goal-setting feature. When combined with immediate feedback and point delivery for achieving progress goals and the opportunity to exchange points for the user's choice of incentive prizes (the shaping process), this feature is expected to increase the probability that users will achieve their goals. Again, since the goals are set within the range of the user's most recent performance measures, differential reinforcement is automatically provided by the method and system for achieving each successive approximation to the target behavior.

The system's classification of foods as healthy, cautionary, or unhealthy is well supported by research on the effects of eating choices on disease risk.

The method and system's feature of automatic calculation and graphical display of the current number of preventable disease risk factors for life-style related diseases (arterial, cancer, diabetes, osteoporosis, respiratory) is based on the user's last seven days of recorded eating, activity, and health measures. A display of advice on how to reduce those risk factors is specific to those currently calculated for the user.

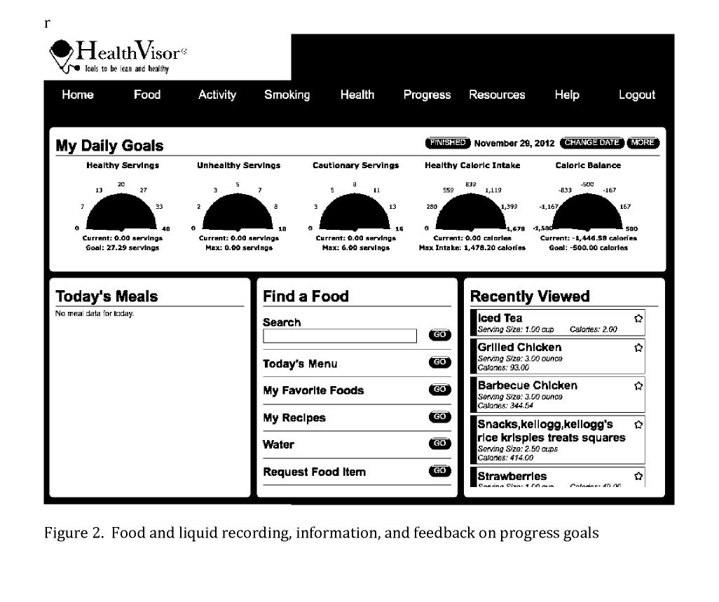

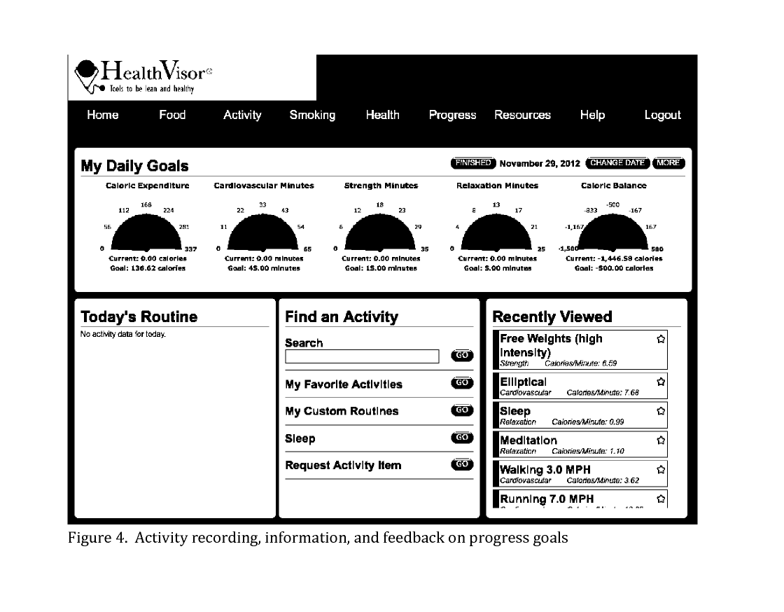

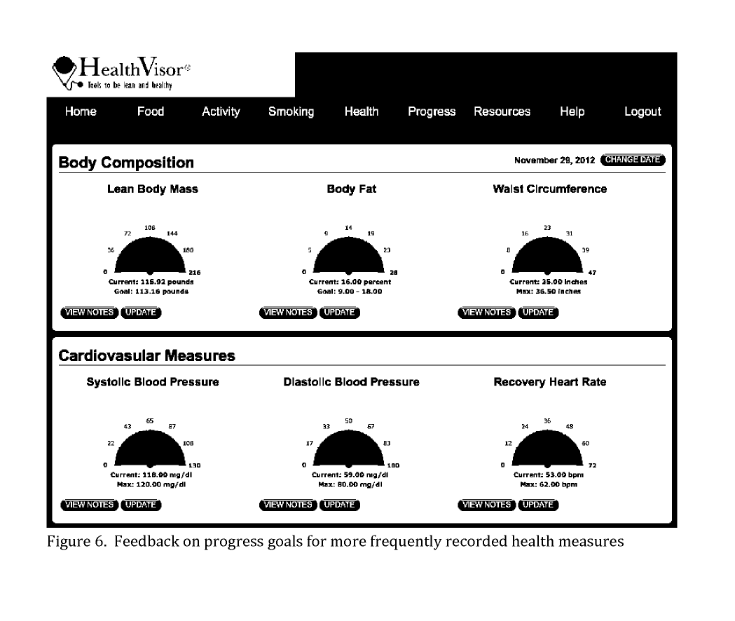

The method and system provides feedback dials for daily progress goals, as in FIGS. 2, 4, and 6 and others, in which are shown the calculated and updated current daily values or totals for measures that predict disease risk based on the user's recorded eating, activity, and health measures. The dials also display current measures along with current personal progress goals, which may be marked in different colors, as red and green areas, on each feedback dial.

The method and system notifies the user immediately, following his or her entry of eating, activity, or health measures, that he or she has achieved one or more progress goals and earned incentive points.

The learning program of the present system and method includes: a) pre- and post-testing for each performance objective, b) automatic sequencing of each learner through the pretest, learning activity, and post-test sequence based on an automatic comparison of the learner's actual performance to performance goals, and c) progress graphs which display the user's “learning efficiency.” That measure is the amount of improvement per amount of learner interaction time with the learning activity for a particular objective.

The system and method has a body shape history and projection feature, which allows users to import digital photos, date stamps them, and arranges them in a slide show based on their chronological order, allowing users to see how their body shapes have changed and may in the future change over time by following the program.

The system and method features calendar graphs that show user progress over time for eating, activity, and health measures, with progress shown both by movement toward long-term goal measures marked on progress graphs for each type of measure.

A personal coaching feature allows only approved coaches to record health measures for a particular user and to access those measures, for personally advising the user on how to achieve health goals and praising the user for making progress.

Users may create and add their own recipes to the method and system database. If the recipe combines items from the database, the method and system will calculate nutrient totals for the new item. The method and system also allows users to create their own workout routines from items in the activity database and automatically calculates total values for that composite item. The method and system allows users to request dietitians to add foods or activities to the database.

Various alterations and modifications may be made to the details of the operation of the present invention without departing from the scope of the invention, which is defined only by the appended claims.

I claim as my invention:

1. A system and method for reducing chronic disease risk and improving health in a user, the system and method comprising:
an Internet-based database containing health, disease-risk, nutrition, and activity information; the database having, an interface that allows the user to record eating, activity, and health measures; and
an automated shaping process means for setting progress goals for eating and activity measures, within the variability of the user's most recently-recorded measures, wherein the goals are calculated to increase the probability that the user will achieve them, the process means providing immediate written and graphic feedback on progress towards achieving said goals, with automated updating of each goal based on new user data.

2. The system defined in claim 1, wherein said automated shaping process further awards incentive points that the user can exchange for his or her choice of incentives when the user achieves any of his or her goals.

3. The system defined in claim 1, wherein eating and activity goals are updated daily.

4. The system defined in claim 1, wherein the automated shaping process further:
sets multiple progress goals for health measures, within the variability of the user's most recent measures and which are calculated to increase the probability that the user will achieve the goals,
provides immediate feedback on progress towards and achievement of goals,
awards points for achieving goals, which the users can exchange for their chosen incentives, and
updates the health measures and goals whenever a new measure is recorded.

5. The system defined in claim 1, wherein said automated shaping process further provides graphical feedback in the form of charts showing user progress over time towards achieving any of long-term disease risk reduction, health, healthy eating, and activity goals.

6. The system defined in claim 1, wherein said automated shaping process further provides advice on how to reduce current disease risk, specific to the individual's current risk factors calculated from the individual's most recent health, eating, and activity measures.

7. The system defined in claim 1, wherein an assigned health coach has access to the user's account, whereby to enable providing effective coaching.

8. The system defined in claim 1, further comprising an interactive learning program means for providing immediate, automated, charted feedback on the efficiency of learner progress toward mastery, wherein efficiency of progress is computed as the ratio of change in the learner's performance frequency divided by minutes of interaction time with the system's learning activity between the pre-test and the post-test.
